(19) United States
(12) Patent Application Publication
(10) Pub. No.: US 2017/0293083 A1
(43) Pub. Date: Oct. 12, 2017

(54) OPTICAL LOOP ENHANCED OPTICAL MODULATORS

(71) Applicants: MICHAEL MENARD, VERDUN (CA); FATEMEH SOLTANI, MONTREAL (CA); ANDREW KIRK, OUTREMONT (CA)

(72) Inventors: MICHAEL MENARD, VERDUN (CA); FATEMEH SOLTANI, MONTREAL (CA); ANDREW KIRK, OUTREMONT (CA)

(21) Appl. No.: 15/482,990

(22) Filed: Apr. 10, 2017

Related U.S. Application Data
(60) Provisional application No. 62/320,706, filed on Apr. 11, 2016.

(51) Int. Cl. G02B 6/293; G02F 1/225

(52) U.S. Cl. CPC G02B 6/29352; G02F 1/225; G02B 6/29338; G02F 2001/212

(57) ABSTRACT

External modulators, variable optical attenuators, optical gates, etc. employing Mach-Zehnder interferometers (MZIs) are a common structure within photonic integrated circuits and solutions for addressing the ever increasing demands for larger bandwidth and higher capacity in telecommunication and datacom networks. In most applications, but particularly data centers with potentially tens of thousands of optical links where direct board level applications would be preferred with CMOS compatibility, low power consumption is required. Equally, reducing the footprint of optical devices whilst increasing the functional integration on a line card for example does little for power consumption unless the device capacitance and drive voltage can be reduced as well. Accordingly, it would be beneficial to provide MZIs that require reduced phase shifts to reduce power consumption as the square of reduced applied voltage. Integrated loop mirror Mach-Zehnder interferometer (MZI) provide such a reduction in required phase shift.

### CROSS-REFERENCE TO RELATED APPLICATIONS

This patent application claims the benefit of U.S. Provisional Patent Application 62/320,706 filed Apr. 11, 2016 entitled “Optical Loop Enhanced Optical Modulators”, currently pending, the entire contents of which are incorporated herein by reference.

### FIELD OF THE INVENTION

This invention relates to optical modulators and more particularly to optical modulators incorporating optical loop mirrors.

### BACKGROUND OF THE INVENTION

Today the Internet comprises over 100 billion plus web pages on over 100 million websites being accessed by nearly 3 billion users conducting approximately 3 billion Google searches per day, sending approximately 150 billion emails per day. With these statistics it is easy to understand but hard to comprehend how much data is being uploaded and downloaded every second on the Internet even before considering the current high growth rate of high bandwidth video. By 2016 this user traffic is expected to exceed 100 exabytes per month, over 100,000,000 terabytes per month, or over 42,000 gigabytes per second. However, peak demand will be considerably higher with projections of over 600 million users streaming Internet high-definition video simultaneously at peak times.

All of this data will flow to and from users via data centers and across telecommunication networks from ultra-long-haul networks down through long-haul networks, metropolitan networks and passive optical networks to users through Internet service providers and then Enterprise/small office-home office (SOHO)/Residential access networks. In the long-haul national and regional backbone networks and metropolitan core networks dense wavelength division multiplexing (DWDM) with channel counts of 40 or 100 wavelengths supporting 10 Gb/s and 40 Gb/s data rates per channel have been deployed over the past decade and are now being augmented with next generation 40 Gb/s and 100 Gb/s technologies for ultra-long-haul, long-haul and metropolitan networks.

External modulators, variable optical attenuators, optical gates, etc. employing Mach-Zehnder interferometers (MZIs) are a common structure within photonic integrated circuits and solutions for addressing these ever increasing demands for larger bandwidth and higher capacity in telecommunication and datacom networks. In most applications, but particularly data centers with potentially tens of thousands of optical links where direct board level applications would be preferred with CMOS compatibility, low power consumption is required. Equally, reducing the footprint of optical devices whilst increasing the functional integration on a line card for example does little for power consumption unless the device capacitance and drive voltage can be reduced as well.

Accordingly, it would be beneficial to provide MZIs that require reduced phase shifts to reduce power consumption as the square of reduced applied voltage. Embodiments of the invention provide such a reduction in required phase shift.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to address limitations within the prior art relating to optical modulators and more particularly to optical modulators incorporating optical loop mirrors.

In accordance with an embodiment of the invention there is provided an optical device comprising:
an input waveguide coupled to a first optical coupler on one end of Mach-Zehnder interferometer;
an optical loop coupled from a first waveguide of a second optical coupler on another one end of the 2×2 Mach-Zehnder interferometer to second waveguide of the second optical coupler on the other end of the 2×2 Mach-Zehnder interferometer; wherein
the optical device goes from maximum transmission back into the input waveguide to minimum transmission back into the input waveguide for a phase shift of π/4 radians.

In accordance with an embodiment of the invention there is provided an optical device comprising:
an input 2×2 optical coupler comprising first and second input waveguides and first and second output waveguides;
an output 2×2 optical coupler comprising third and fourth input waveguides and third and fourth output waveguides;
a first optical waveguide coupled from the first output waveguide to the third input waveguide;
a second optical waveguide coupled from the second output waveguide to the fourth input waveguide;
a third optical waveguide coupled from the third output waveguide to the fourth output waveguide; wherein
an optical signal coupled to either the first input waveguide or second input waveguide is coupled in predetermined ratio back to the first input waveguide or second input waveguide in dependence upon the phase shift induced within at least one of the first optical waveguide and the second optical waveguide.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1A depicts a generalized optical modulator according to an embodiment of the invention exploiting an optical loop mirror in conjunction with an active optical element;

FIG. 1B depicts a schematic of an optical modulator according to an embodiment of the invention exploiting an optical loop mirror in conjunction with an optical Mach-Zehnder Interferometer (MZI);

FIG. 2A depicts the theoretical output versus phase shift for optical loop enhanced MZI (OLE-MZI) according to an embodiment of the invention;

FIG. 2B depicts a cross-section of a silicon-on-insulator (SOI) optical loop enhanced MZI (OLE-MZI) according to an embodiment of the invention;

FIG. 2C depicts the voltage—current characteristic for a reverse bias diode providing phase modulation within a silicon-on-insulator (SOI) optical loop enhanced MZI (OLE-MZI) according to an embodiment of the invention;

FIG. 2D depicts effective index change versus voltage characteristic for a reverse bias diode providing phase modulation within a silicon-on-insulator (SOI) optical loop enhanced MZI (OLE-MZI) according to an embodiment of the invention;

FIG. 2E depicts optical propagation loss versus voltage characteristic for a reverse bias diode providing phase modulation within a silicon-on-insulator (SOI) optical loop enhanced MZI (OLE-MZI) according to an embodiment of the invention;

FIG. 3 depicts an optical image of a fabricated optical loop enhanced MZI (OLE-MZI) according to an embodiment of the invention;

FIG. 4 depicts the measured wavelength response of the exemplary OCE-MZI according to an embodiment of the invention depicted in FIG. 3 employing adiabatic-3 dB couplers normalized to a reference waveguide;

FIG. 5 depicts the measured DC response of the exemplary OCE-MZI according to an embodiment of the invention depicted in FIG. 3 employing adiabatic-3 dB couplers normalized to a reference waveguide;

FIG. 6 depicts a schematic of a RF test measurement system for characterizing an exemplary OCE-MZI according to an embodiment of the invention;

FIGS. 7 to 10 depict eye-diagrams obtained at approximately 8 Gb/s, 10 Gb/s, 12 Gb/s and 14 Gb/s obtained with the test configuration of FIG. 6 with an exemplary OCE-MZI according to an embodiment of the invention; and

FIG. 11 depicts experimental bit-error rate (BER) versus received power for an exemplary OCE-MZI according to an embodiment of the invention at 12 Gb/s.

### DETAILED DESCRIPTION

The present invention is directed to ratings and more particularly to optical modulators and more particularly to optical modulators incorporating optical loop mirrors.

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function and arrangement of elements without departing from the spirit and scope as set forth in the appended claims.

1. Optical Loop Enhanced Mach-Zehnder Interferometer (OLE-MZI) Modulator Theory

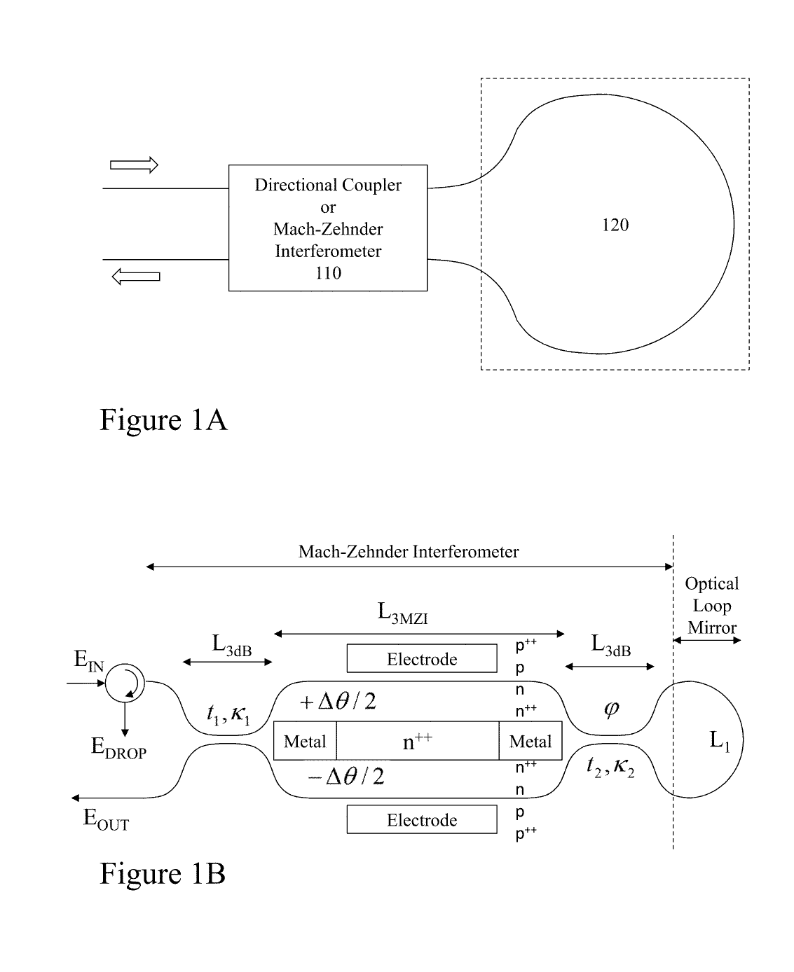

Referring to FIG. 1A there is depicted a schematic of a generalized optical loop enhanced modulator (OLEM) according to an embodiment of the invention. Accordingly, an active optical element 110, e.g. a directional coupler or Mach-Zehnder interferometer, has its outputs coupled to a loop mirror 120. Accordingly, the optical signal propagates through the active region twice and accordingly only half the length or voltage is required in order to induce the required phase shift as a prior art modulator of either design.

Referring to FIG. 1B there is depicted a schematic of an optical loop enhanced Mach-Zehnder Interferometer (OLE-MZI) according to an embodiment of the invention wherein the output ports of a conventional MZI are coupled to an optical loop mirror. Accordingly, in order to propagate through the OLE-MZI the optical signal must pass through the pair of 3 dB couplers and straight phase-shifter waveguides of the MZI twice. Accordingly, the transfer function of the OLE-MZI is given by Equation (1). Assuming loss-less propagation in the couplers, Equations (2A) and (2B), and identical couplers (κ₁=κ₂) then the performance of the OLE-MZI is defined by Equations (3) to (5B) respectively, where is the propagation constant of the waveguides, L₁ is the length of the loop. The angle θ is the fixed phase difference between the MZI arms and Δθ is the phase shift obtained through the modulation of the effective refractive index of the MZI arms with the electro-optic effect. The coupling coefficient of identical 3 dB couplers is represented by κ.

$$\begin{matrix}\begin{matrix}[ \begin{matrix}{E}_{THRU} \\ {E}_{DROP}\end{matrix} ] = [ \begin{matrix}{t}_{1} & {κ}_{1} \\ {κ}_{1} & {t}_{1}\end{matrix} ] \cdot [ \begin{matrix}{e}^{- i θ} & 0 \\ 0 & {e}^{- i ( θ + Δθ )}\end{matrix} ] \cdot [ \begin{matrix}{t}_{2} & {κ}_{2} \\ {κ}_{2} & {t}_{2}\end{matrix} ] \cdot [ \begin{matrix}{e}^{- j β {L}_{1}} & 0 \\ 0 & {e}^{- j β {L}_{1}}\end{matrix} ] \\ [ \begin{matrix}{t}_{2} & {κ}_{2} \\ {κ}_{2} & {t}_{2}\end{matrix} ] \cdot [ \begin{matrix}{e}^{- i θ} & 0 \\ 0 & {e}^{- i ( θ + Δθ )}\end{matrix} ] \cdot [ \begin{matrix}{t}_{1} & {κ}_{1} \\ {κ}_{1} & {t}_{1}\end{matrix} ] \cdot [ \begin{matrix}{E}_{IN} \\ 0\end{matrix} ]\end{matrix} & ( 1 ) \\ {t}_{1}^{2} + {κ}_{1}^{2} = 1 \\ {t}_{2}^{2} + {κ}_{2}^{2} = 1 & ( 2 A ) \\ \frac{{E}_{THRU}}{{E}_{IN}} = [ {( ( 1 - {κ}^{2} ) {e}^{- i θ} + {κ}^{2} {e}^{- i ( θ + Δ θ )} )}^{2} + ( κ \sqrt{1 - {κ}^{2}} {( {e}^{- i θ} + {e}^{- i ( θ + Δ θ )} )}^{2} ) ] \cdot exp ( - j β {L}_{1} ) & ( 3 ) \\ \frac{{E}_{THRU}}{{E}_{IN}} = κ \sqrt{1 - {κ}^{2}} {( {e}^{- i θ} + {e}^{- i ( θ + Δ θ )} )}^{2} \cdot exp ( - j β {L}_{1} ) & ( 4 ) \\ θ = \frac{2 π}{λ} {n}_{EFF - Si} {L}_{MZI} & ( 5 A ) \\ Δθ = \frac{2 π}{λ} {n}_{EFF} {L}_{MZI} & ( 5 B )\end{matrix}$$

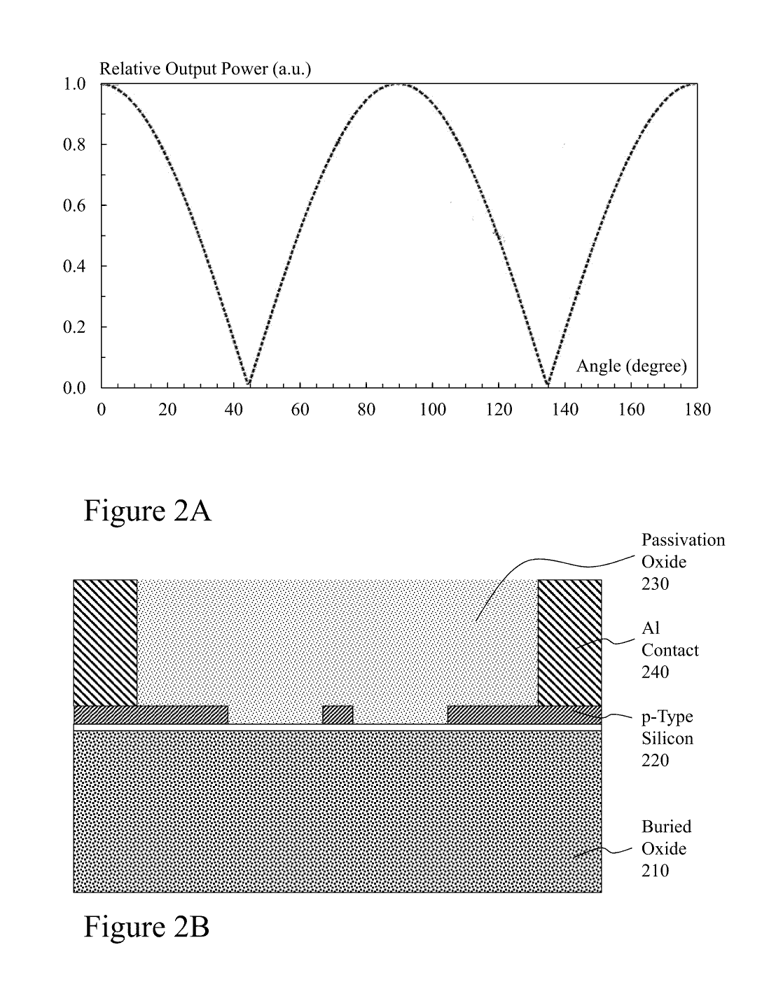

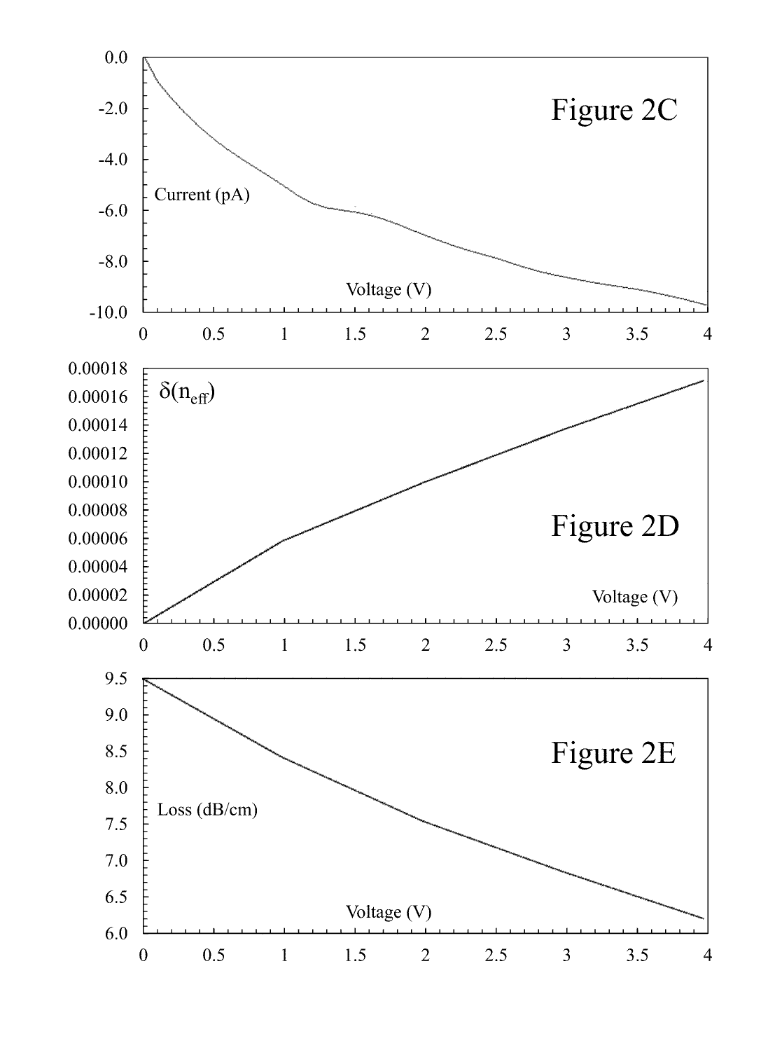

Equations (1) to (5B) show the dependence of the through port and the drop port on the coupling coefficient of the couplers. Accordingly, plotting the resulting ratio E_{THRU}/E_{IN}, or relative output power, for varying θ for the OLE-MZI yields the transfer curve depicted in FIG. 2A where it can be seen that rather than requiring an induced phase shift of 90° as with a standard prior art MZI to go from 100% to 0% that the OLE-MZI requires an induced phase shift of 45° . Accordingly, this reduction in the full modulation phase shift will result in applying lower voltages to the modulator and consequently the device has lower power consumption. In fact, at half the required drive voltage power consumption is 25% of the prior art MZI.

2. Design

By varying the coupling ratio from 50% to 100% it is possible to change the device from a transmission device to reflection device. In these limits using the optical loop mirror after the MZI the input light can be directed to the output as transmission port (50% coupling) or back to the input as reflection port (100% coupling). Accordingly, the port, E_{THRU}, can be full transmission or zero transmission at no applied phase shift.

Referring to FIG. 2B there is depicted a cross-section of a silicon-on-insulator (SOI) optical loop enhanced MZI (OLE-MZI) according to an embodiment of the invention. As depicted a buried oxide layer 210 has disposed atop it a p-type silicon 220 layer which is patterned to form a rib which is then buried with a passivation oxide 240. Laterally disposed p-type silicon 220 regions are metallised with aluminum (Al) contacts 230 for biasing and control. Due to the typical refractive indices of the materials at λ=155 μm the silicon 220 rib is 0.5 μm wide and has a thickness of 0.22 μm which is etched down by 0.13 μm . The lateral gaps between the rib and silicon 220 (p-type 10Ω·cm (10¹⁵ cm⁻³)). The buried oxide 210 was set at a thickness of 2 μm . Simulations of the OLE-MZI according to this embodiment of the invention with SOI waveguides were performed.

Referring to FIG. 2C there is depicted the simulated voltage-current characteristic for a reverse bias diode providing phase modulation within the SOI OLE-MZI according to the geometry in FIG. 2B. Similarly, FIG. 2D depicts the simulated effective index change versus voltage characteristic for a reverse bias diode providing phase modulation within the SOI OLE-MZI whilst FIG. 2E depicts the simulated optical propagation loss versus voltage characteristic of the reverse biased diode SOI OLE-MZI.

Based upon these simulations then at 2V bias the effective index change is Δn_{EFF}=10⁻⁴ yielding a length, L_{MZI}=3.875 mm , for the MZI. In contrast raising the maximum applied voltage to 4V increases the effective index change to Δn_{EFF}=1.7×10⁻⁴ L_{MZI}=2.28 mm . The length of the 3 dB directional couplers was calculated to be L_{3dB-COUPLER}7.61 μm.

Prototype OLE-MZI devices were fabricated in the A*STAR Institute of Microelectronics (IME) foundry in Singapore and were designed to exploit active control with PN diodes in reverse bias to exploit the electro-optic effect. Push-pull travelling wave electrodes were employed on both arms of a symmetric MZI as phase-shifters so that by applying voltage to electrodes the coupling of light passing through loop can be modified allowing the transmission and reflection behavior of the device to be characterised and/or used as an external modulator to a CW optical source.

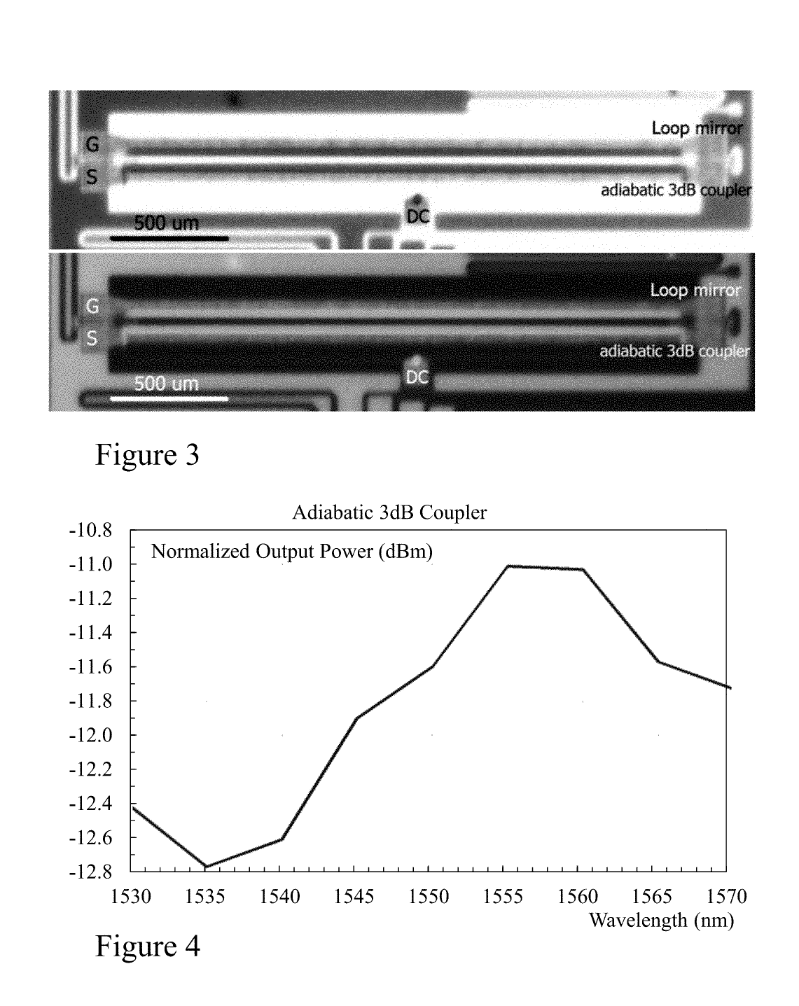

Referring to FIG. 3 the ground (G)—signal (S) pads for RF probes can be seen at either end of the MZI. Also evident is a DC pad placed in the middle of the arms of the MZI. The adabatic-3 dB couplers are identical for both sides. The loop is evident at the right hand side of FIG. 3 the picture, also the input and output ports are visible in the left side. Exemplary prototype device dimensions were GS tracks of width 50 μm, GS track offset from waveguides 2 μm , MZI waveguide separation 100 μm , MZI length 3 mm , and directional coupler waveguide separation 200 nm . The doping varied from n⁺⁺ in the central region of the MZI with the DC bias electrodes to p⁺⁺ at the GS electrodes.

3. DC Performance

Experimental results for prototype devices have been obtained with applied reverse bias at 1550nm. The DC voltage was connected directly on the GS striplines. Referring to FIG. 4 the wavelength response of an OLE-MZI device according to an embodiment of the invention with adaiabtic-3 dB couplers is depicted normalized to a reference waveguide. Based upon these measurements the OLE-MZI has broad band wavelength characteristics.

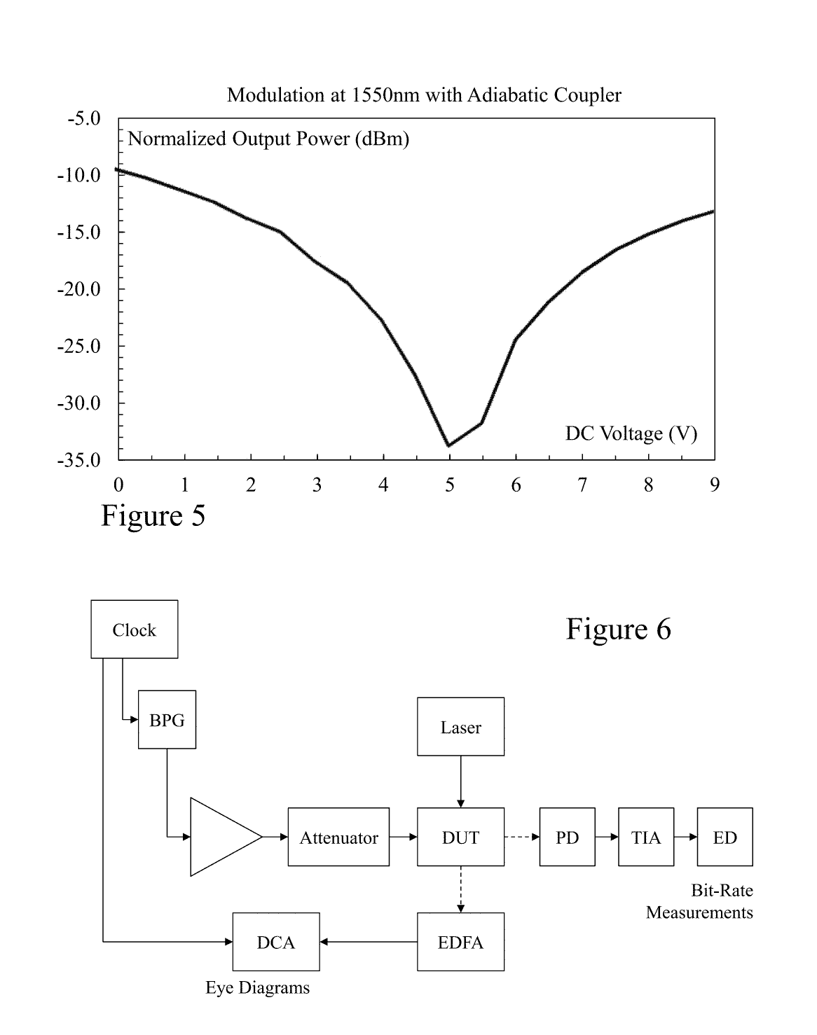

The DC modulation characteristics of OLE-MZI on an exemplary prototype are depicted in FIG. 5 where it is evident that the minimum transmission occurs at 5V and the modulation depth was approximately 25 dB. The propagation loss of the reference waveguide was 16.86 dB. The 1V difference for the modulation voltage between simulated and experimental results was attributed to the values of carrier density employed in the simulations/achieved in fabrication together with a non-robust fabrication methodology for the prototype devices.

4. RF Performance

The experimental RF set-up employed to test the RF performance/eye diagram of the prototype OLE-MZI is depicted in FIG. 6. A SHF bit pattern generator (BPG) was employed to provide a 0.4V_{PP} PRBS 2³¹-1 signal. A reverse bias voltage of 4.0 V was applied to the OLE-MZI and the RF drive signal was amplified with a RF amplifier and in order to prevent breakdown of the PN diodes during operation of the device, and to limit the deriving voltage, a 10 dB attenuator was used before the device under the test (DUT). GS probes are placed at two ends of the device to apply the RF signal with a 50Ω termination applied at the right end of the travelling wave electrode on one of the GS probes to avoid reflections. Also, a DC pad was placed in the middle of the MZI to control DC bias. A tunable laser source was used to provide the optical signal at 1550 nm. The optical input and output were coupled vertically to the DUT by fiber arrays. The modulated optical output signal from the OLE-MZI was amplified with an erbium-doped fiber amplifier (EDFA) before being coupled to the high speed photodetector ad the digital communication analyzer (DCA).

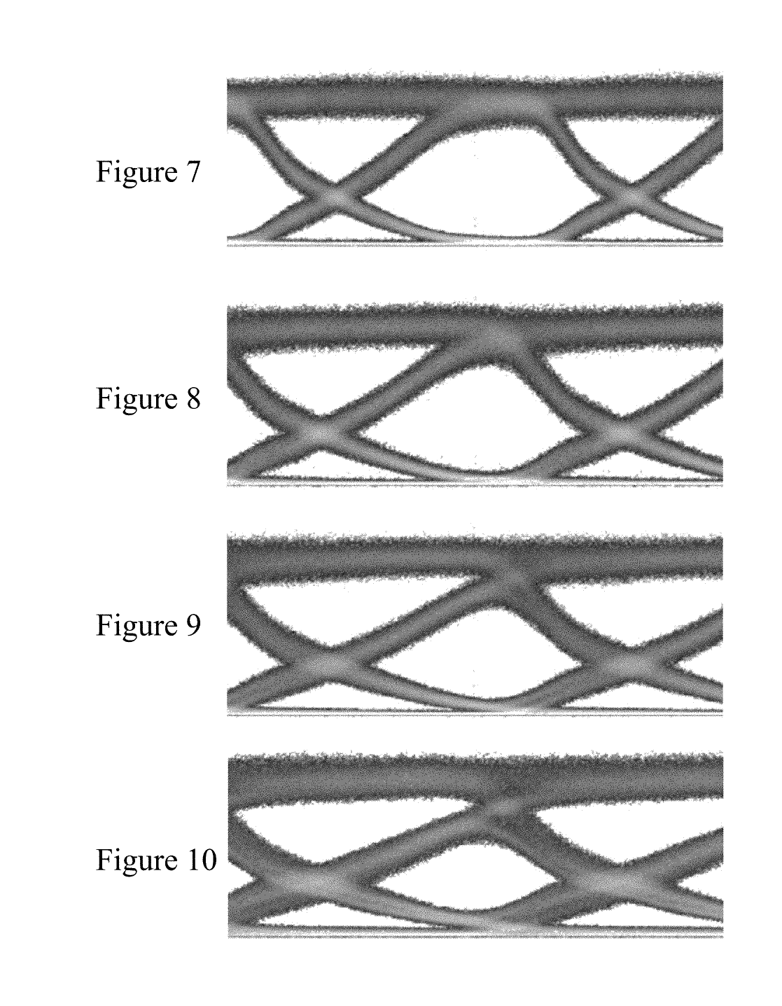

Optical eye diagrams at different bitrates were obtained of which examples are depicted in FIGS. 7 to 10. As evident clear open eyes were observed up to 12 Gb/s. From the eye diagrams, it appears that the transmission speed is limited by distortion and not a reduction in extinction ratio (ER). In fact, at over 10 dB the ER is very high. If this apparent distortion is caused by the modulation when the signal is traveling back through the MZI then an optimized design could allow the modulation speed to be increased.

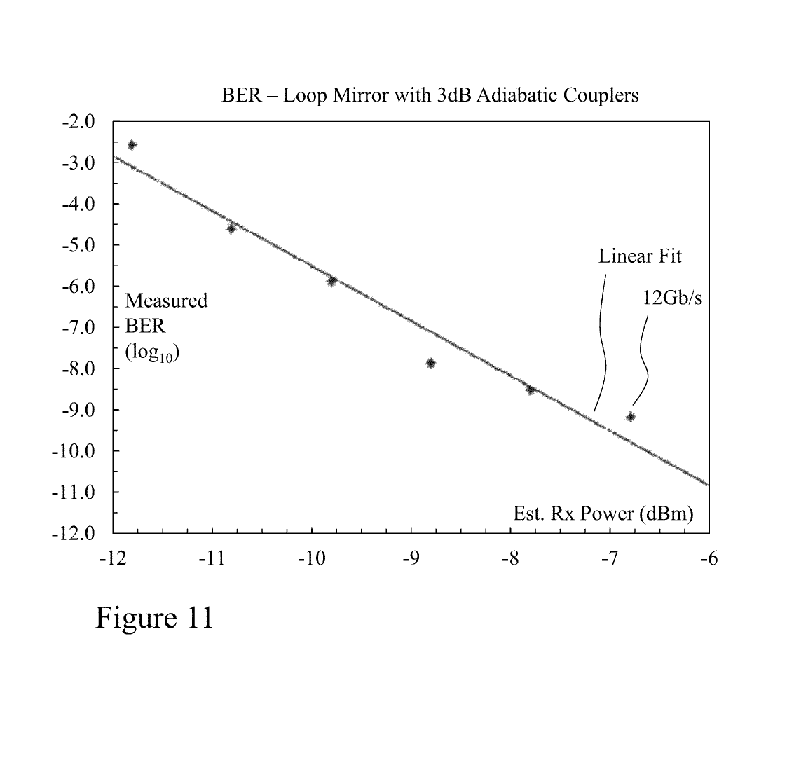

Bit error rate (BER) sensitivity analysis of modulated optical signal was performed for the modulated optical signal via a photodetector (PD) connected to a trans-impedance amplifier (TIA). The PD and the TIA together make a photoreceiver unit and the signal is analyzed with an error detector (ED). The resulting BER measurements are depicted in FIG. 11 for measurements at 12 Gb/s. These measurements indicate that with zero errors detected in 3 terabits it is possible to achieve BER<10⁻⁹ at 12 Gb/s.

Within the embodiments of the invention described and depicted supra in respect of FIGS. 1 through 11 silicon waveguides have been described. It would be evident to one skilled in the art that embodiments of the invention may exploit silicon-on-insulator waveguides exploiting thermal and diode based control/tuning of the OLE-MZI that may be implemented with the same waveguide material system and other material systems. It would be apparent that optical waveguides exploiting silicon-on-insulator may include, but not be limited to, silicon, germanium, silicon nitride-silicon, intrinsic BOX layers, fabricated BOX layers, and silicon-oxide clad silicon.

However, it would be evident to one skilled in the art that the OLE-MZI concept may be applied to other waveguide geometries including, but not limited to, polymer-on-silicon, doped silicon, silicon-germanium, polymeric waveguides, InGaAsP based semiconductor waveguides, GaAs based waveguides, III-V semiconductor materials, II-VI semiconductor materials, lithium niobate, lithium tantalite, and other materials within which optical waveguides can be formed exhibiting induced optical index changes to generate the required phase shift for controlling the OLE-MZI. It would be evident that the optical waveguides may be formed through a range of techniques including, but not limited to, material composition, rib-loading, ridges, doping, ion-implantation, and ion-exchange. Refractive index changes within the phase shifting elements may be induced through the linear electro-optical effect, PN or PIN diode reverse bias, and current injection.

It would be apparent that OLE-MZI modulators as described above in respect of embodiments of the invention may be integrated with monitoring photodiodes for feedback and control either through direct integration or through hybrid integration.

It would be apparent that OLE-MZI modulators as described above in respect of embodiments of the invention may be integrated with semiconductor lasers through hybrid integration including, but not limited to, discrete DFB lasers, discrete DBR lasers, arrayed DFB lasers, and arrayed DBR lasers. Optionally discrete or arrayed semiconductor optical amplifiers (SOA) may be employed.

It would be apparent that OLE-MZI modulators as described above in respect of embodiments of the invention may be integrated with control and drive circuits such as through the formation of OLE-MZI modulators on substrates with integral CMOS electronics, hybrid integration of CMOS electronics or through driver amplifiers hybridly integrated and manufactured within InP, GaAs, or SiGe for example.

It would be apparent that the directional coupler elements within the Mach-Zehnder interferometer/ring waveguide elements of the OLE-MZI modulators described above may be replaced by other 2×2 3 dB splitter elements including, but not limited to, multimode interferometers (MMIs), X-junctions, asymmetric X-junctions, zero gap directional couplers, and multiple waveguide couplers. Further, it would be evident that such coupler elements may include additional electrical control signals to tune the split ration of the coupler element.

Within these different materials the design of the OLE-MZI may be varied to accommodate the requirements of the waveguides such that the loop may be implemented in alternate approaches including, but not limited, meandering optical waveguides, single ring resonator with direct coupling in and out, multiple coupled ring resonators with 100% coupling in and out, waveguides coupled to a reflective interface, corner mirrors, etc. Optionally, the loop may be a pair of waveguides coupled to a retro-reflector element such as half of a 2×2 Mach-Zehnder interferometer with reflective waveguides and appropriate phase shift an optical coupler with reflector(s) or directional coupler with reflector(s) within the coupler region etc.

It would also be evident that the OLE-MZI may employ a single input waveguide with a 3 dB Y-junction splitter or other 3 B splitter element wherein separation of the input and output signals is achieved through a circulator.

Devices according to embodiments of the invention may be implemented as standalone circuits coupled to optical fibers either directly or through the use of intermediate coupling optics, e.g. ball lenses, spherical lenses, graded refractive index (GRIN) lenses, etc. for free-space coupling into and/or from another waveguide device. Tapered optical fibers may be employed in other embodiments. Silicon micromachining may be employed in embodiments of the invention to align the input/output optical waveguides to the OLE-MZI. In other embodiments the OLE-MZI may be integrated monolithically or hybridly with control (e.g. CMOS) and drive electronics (e.g. Si high speed amplifiers, GaAs, InP, SiGe, etc.

Embodiments of the OLE-MZI as depicted and described may be employed as amplitude modulators, variable optical attenuators, and high speed optical gates. Further, embodiments of the invention may be operated solely in reverse bias, solely in forward bias, or through a combination of positive and negative bias. Further different electrodes may be employed for forward and reverse bias according to the design of the OLE-MZI.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. An optical device comprising:
an input waveguide coupled to a first optical coupler on one end of Mach-Zehnder interferometer;
an optical loop coupled from a first waveguide of a second optical coupler on another one end of the 2×2 Mach-Zehnder interferometer to second waveguide of the second optical coupler on the other end of the 2×2 Mach-Zehnder interferometer; wherein
the optical device goes from maximum transmission back into the input waveguide to minimum transmission back into the input waveguide for a phase shift of π/4 radians.

2. The optical device according to claim 1, further comprising
an output waveguide coupled to the first optical coupler of the 2×2 Mach-Zehnder interferometer; wherein
the first optical coupler and second optical coupler are 3 dB optical couplers.

3. The optical device according to claim 1, wherein the first optical coupler is selected from the group comprising a Y-junction, an X-junction, a multimode interferometer (MMI), an asymmetric X-junctions, a zero gap directional couplers, a directional coupler and a multiple waveguide coupler.

4. The optical device according to claim 1, wherein the optical loop employs an optical element selected from the group comprising a curved waveguide, a meandering optical waveguide, a ring resonator with direct coupling in and out, a set of coupled ring resonators, waveguides coupled to a reflective interface, waveguides coupled to one or more turning mirrors or corner mirrors, waveguides coupled to a retro-reflector.

5. An optical device comprising:
an input 2×2 optical coupler comprising first and second input waveguides and first and second output waveguides;
an output 2×2 optical coupler comprising third and fourth input waveguides and third and fourth output waveguides;
a first optical waveguide coupled from the first output waveguide to the third input waveguide;
a second optical waveguide coupled from the second output waveguide to the fourth input waveguide;
a third optical waveguide coupled from the third output waveguide to the fourth output waveguide; wherein
an optical signal coupled to either the first input waveguide or second input waveguide is coupled in predetermined ratio back to the first input waveguide or second input waveguide in dependence upon the phase shift induced within at least one of the first optical waveguide and the second optical waveguide.

6. The optical device according to claim 5, wherein the optical device goes from maximum transmission to minimum transmission for a phase shift of π/4 radians.

7. The optical device according to claim 5, wherein at least one of the first optical coupler and second optical coupler is selected from the group comprising an X-junction, a multimode interferometer (MMI), an asymmetric X-junctions, a zero gap directional couplers, a directional coupler and a multiple waveguide coupler.

8. The optical device according to claim 5, wherein the optical loop employs an optical element selected from the group comprising a curved waveguide, a meandering optical waveguide, a ring resonator with direct coupling in and out, a set of coupled ring resonators, waveguides coupled to a reflective interface, waveguides coupled to one or more turning mirrors or corner mirrors, waveguides coupled to a retro-reflector.
